(19) United States
(12) Patent Application Publication
(10) Pub. No.: US 2008/0313415 A1
(43) Pub. Date: Dec. 18, 2008

(54) Copied file execution authorization using RFID tag

(75) Inventor: David A. Luehmann, Sammamish, WA (US)

Correspondence Address: WESTMAN CHAMPLIN (MICROSOFT CORPORATION), SUITE 1400, 900 SECOND AVENUE SOUTH, MINNEAPOLIS, MN, 55402-3244, US

(73) Assignee: Microsoft Corporation, Redmond, WA (US)

(21) Appl. No.: 11/818,313

(22) Filed: Jun. 14, 2007

(51) Int. Cl. G06F 12/16

(52) U.S. Cl. 711/162; 711/E12.103

(57) ABSTRACT

In a method for controlling execution of a digital copy of an original file, a radio frequency identification (RFID) tag read operation is performed using an RFID tag reader. A determination is then made as to whether the physical storage medium is present or absent based on the RFID tag read operation. The digital copy of the original media file is executed when the physical storage medium is determined to be present and execution of the digital copy of the original media file is disabled when the physical storage medium is determined to be absent.

### BACKGROUND OF THE INVENTION

Authorized copies of computer applications and programs, music, videos, games and other digital content (hereinafter “original files”) are typically stored on an authorized physical storage medium for sale to consumers. Exemplary physical storage media include optical storage medium such as a compact disks (CD) or digital versatile disk (DVD) and programmable memories such as flash memory drives.

The purchase of the authorized physical storage medium typically grants the owner a license for limited use of the original file. In some instances, the original files are secured in order to prevent unauthorized reproduction of the original files. For example, it is common for movies and video games to be secured to make them more difficult to copy or “rip” to a hard drive or other physical storage medium. As a result, the content must generally be accessed through the direct use of the authorized physical storage medium.

While such security measures may be necessary to reduce pirating of the original files, there are undesirable consequences. For example, the requirement that the original files can only be accessed through the direct use of the authorized physical storage medium can be very inconvenient. For instance, in order to switch one movie stored on an authorized DVD to another typically requires the user to find the authorized DVD containing the desired movie, remove the current DVD from the DVD player, install the newly selected DVD containing the desired movie into the DVD player and return the replaced DVD to where it can be relocated at another time.

An additional consequence to the piracy protections for original files is that the owner of the authorized physical storage medium is unable to make and use a backup copy of the original file. As a result, a legitimate owner of the authorized physical storage medium will likely be forced to repurchase the product in the event that the authorized physical storage medium containing the original file becomes damaged.

The discussion above is merely provided for general background information and is not intended to be used as an aid in determining the scope of the claimed subject matter.

### SUMMARY OF THE INVENTION

A method, implemented using a microprocessor, for controlling execution of a digital copy of an original file is disclosed. In the method, a radio frequency identification (RFID) tag read operation is performed using an RFID tag reader. A determination is then made as to whether the physical storage medium is present or absent based on the RFID tag read operation. The digital copy of the original media file is executed when the physical storage medium is determined to be present and execution of the digital copy of the original media file is disabled when the physical storage medium is determined to be absent.

Another embodiment is directed to a system for controlling execution of a digital copy of an original file, wherein the original file is stored in a physical storage medium. The system includes a data store that contains the digital copy of the original file, an RFID tag reader and a microprocessor. Instructions are stored in a tangible medium of the system and are executable by the microprocessor. The instructions include: an instruction to receive an instruction to execute the digital copy of the original file contained in the data store; an instruction to perform a RFID tag read operation using the RFID tag reader; an instruction to determine whether the physical storage medium is present or absent based on the RFID tag read operation; an instruction to execute the digital copy of the original media file when the physical storage medium is determined to be present; and an instruction to disable the execution of the digital copy of the original media file when the physical storage medium is determined to be absent.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a flowchart illustrating embodiments of a method for controlling execution of a digital copy of an original file.

FIG. 2 is a simplified diagram of embodiments of an exemplary system for implementing the method of FIG. 1.

FIG. 3 is a flowchart illustrating an embodiment of a method of determining whether a physical storage medium is present or absent.

FIG. 4 is a simplified block diagram of the system in accordance with one embodiment that includes a computer.

FIG. 5 is a simplified block diagram of the system in accordance with one embodiment that includes a game console.

### DETAILED DESCRIPTION

In general, embodiments allow a user to execute a copy of an original file when a RFID tag corresponding to the physical storage medium containing the original file is detectable by the system being used to execute or play the copy of the original file. If the RFID tag is not detected by the system, execution of the copy of the original file is disabled. Some exemplary advantages of embodiments include providing the user with the convenience of being able to copy the original file for the purpose of backing up the original file and/or providing convenient access to the original file. Additionally, embodiments provide security from piracy because the copy of the original file cannot be executed without the presence of the RFID tag corresponding to the physical storage medium containing the original file, such as a licensed copy of the original file.

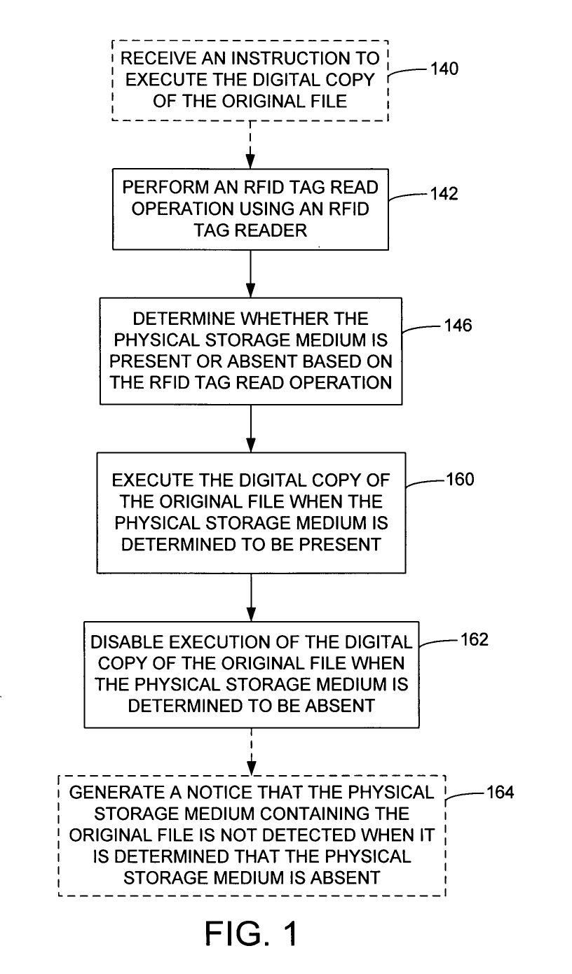

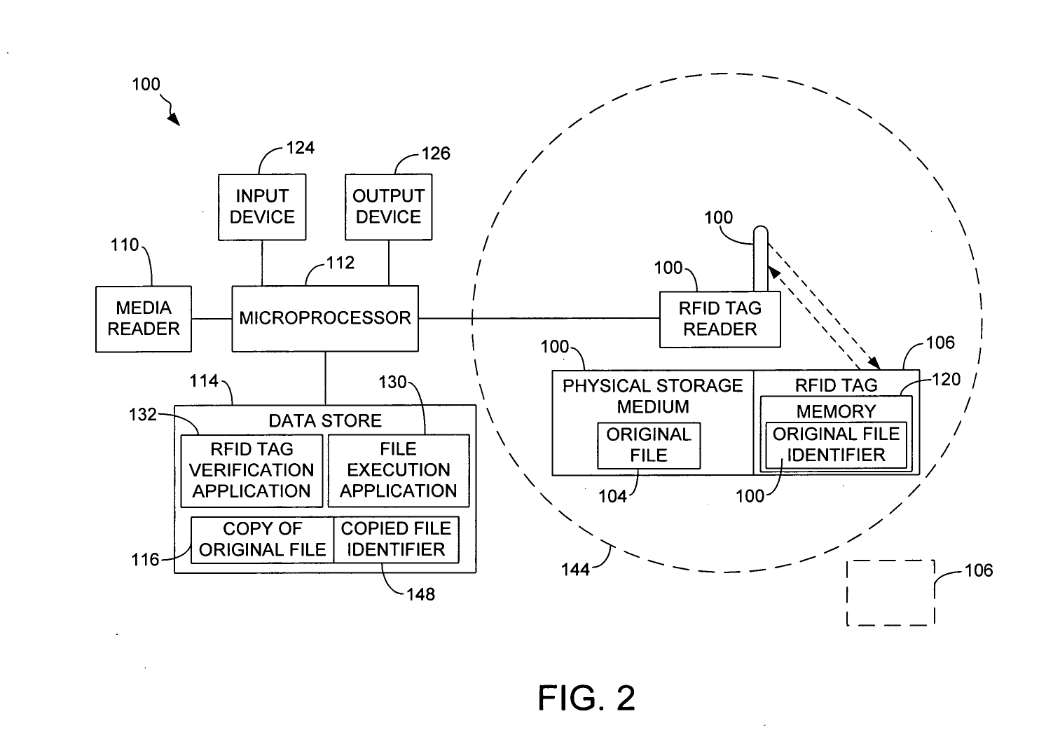

FIGS. 1 and 2 respectively provide a flowchart illustrating embodiments of a method for controlling execution of a digital copy of an original file and a simplified diagram of embodiments of an exemplary system 100 for implementing the method.

Embodiments of the system 100 may include, but are not limited to, a physical storage medium 102 containing an original file 104, a RFID transponder or tag (hereinafter “RFID tag”) 106, a RFID transceiver/interrogator (hereinafter “RFID tag reader”) 108, a media reader 110, a microprocessor 112 and a data store 114.

The original file 104 contained in the physical storage medium 102 corresponds to the authorized or legitimate software product. Thus, while the original file 104 may be one of many copies of the original file 104, it is intended to describe the product that is sold to consumers typically under an associated license agreement. The purchase of the physical storage medium 102 containing the original file 104 generally grants the user a license to use the original file 104 in accordance with the associated license agreement.

Exemplary embodiments of the original file 104 include those that can be executed or played by the microprocessor or central processing unit 112 of a computing device of the system 100, such as a media player (e.g., a portable media player, a compact disk (CD) player, a digital video disk (DVD) player), a game console, and a personal computer, for example. The original file 104 may represent one or several separate files.

The original file 104 can take on many different forms. Exemplary embodiments of the original file 104 include a digital video file (e.g., a movie), a digital audio file (e.g., music), a video game, and a computer program. Exemplary types of digital video files (e.g., movies) include wmv, mpeg, avi, etc. Exemplary types of digital audio files include wma, wav, au, mp3, etc. Exemplary video games include those produced for personal computers and dedicated gaming consoles (e.g., Xbox 360™ video game and entertainment system). Exemplary computer programs include those executable by personal computing devices (e.g., personal computer, personal digital assistant, etc.) such as word processing programs, (e.g., MICROSOFT WORD distributed by MICROSOFT Corporation of Redmond, Wash.), operating systems (e.g., Windows Vista™ operating system) and other programs sold to consumers.

The physical storage medium 102 can take on many different forms. Exemplary physical storage media include CD-ROM's, digital versatile disks (DVD) or other optical disk storage media, flash memory drives, hard drives, RAM, ROM, EEPROM, magnetic cassettes, magnetic tape, magnetic disk storage or other magnetic storage devices, or any other medium which can be used to store the desired information.

The media reader 110 can be used to access the original file 104 on the physical storage medium 102. Exemplary media readers include a CD player, a DVD player, a flash memory reader, or other device through which the original file 104 on the physical storage medium 102 can be accessed.

In one embodiment of the method, the user of the system 100 copies or rips the original file 104 to the data store 114 to thereby form a digital copy of the original file 116 in the data store 114. For example, one may rip or copy a music file (i.e., original file 104) from an authorized copy of the original file 116 stored on a CD (i.e., physical storage medium) to the hard drive (i.e., data store) of their personal computer. The ripped music file constitutes the copy of the original file 116.

As used herein, the act of copying of the original file 104 to the data store 114 also includes the installation of a computer program. In this case, the one or more files stored on the physical storage medium 102 represent the original file 104 and the one or more files installed in the data store 114 as a result of the installation of the computer program represent the copy of the original file 116, even though the copy of the original file 116 may not be an exact or substantially exact copy of the original file 104. For instance, the original file 104 can be in the form of a licensed copy of a video game stored on a DVD (i.e., physical storage medium). The installation of the video game from the DVD to a hard drive (i.e., data store) of a personal computer or game console may involve the copying, extraction and/or manipulation of multiple files from the DVD during the installation of the game to the hard drive. The resultant installed filed corresponding to the video game constitute the copy of the original file 116.

The data store 114 represents a tangible data storage medium. Exemplary embodiments of the data store 114 include a hard drive, optical storage medium, or flash memory of the system 100, a remote data store or data server, or other tangible data storage medium.

The RFID tag 106 is associated with the physical storage medium 102 containing the original file 104 and/or the original file 104. In one embodiment, the RFID tag 106 includes a memory 118, such as non-volatile memory, containing data.

The tag 106 can be programmed with information including, for example, data about the original file 104, the physical storage medium 102, copyright information, license information and other information.

In one embodiment, the RFID tag 106 is programmed to include an original file identifier 120 in the memory 118, which identifies the original file 104 and/or the physical data storage medium 102. In one embodiment, the original file identifier 120 is serialized so that it may be distinguished from the original file identifiers corresponding to the same original files 104 that are stored on other physical storage media 102. In another embodiment, the original file identifier 120 uniquely identifies the original file 104 such that it is distinguishable from the original file identifiers corresponding to different original files 104. For example, an original file identifier 120 corresponding to an original file 104 containing a music file will be distinguishable from that corresponding to another original file 104 containing a different music file.

In one embodiment, the RFID tag 106 is removably or permanently coupled to the physical storage medium 102. The coupling of the RFID tag 106 to the medium 102 can be accomplished using any suitable means. In one embodiment, the RFID tag 106 is embedded into the physical storage medium 102 or a portion of the physical storage medium 102. One exemplary manner in which the RFID tag 106 can be coupled to an optical data storage disk, such as a CD or DVD, is described in U.S. Pat. No. 7,071,825, which is assigned to Microsoft, Corporation. of Redmond, Wash.

In another embodiment, the RFID tag 106 is separate from the physical storage medium 102. Here, the RFID tag 106 is provided on a card or other substrate, for example.

The RFID tag reader 108 includes an antenna 122. The antenna 122 may comprise a single antenna or multiple antennae and can be any appropriate type, such as an omnidirectional antenna. In one embodiment, the RFID tag reader 108 is attached to the computing device (e.g., computer, game console, media player or other computing device) that contains the microprocessor 112 and communicates with the microprocessor 112 through an appropriate communications bus. Alternatively, the RFID tag reader 108 may be formed as a separate device from that containing the microprocessor 112. A universal serial bus (USB) or other wired or wireless communications link can be used for data transfer between the reader 108 and the microprocessor 112.

The microprocessor 112 represents one or more devices configured to control operations of the system 100. Exemplary operations include data communications in the system 100 including data communications with the RFID tag reader 108, the data store 114 or other memory of the system 100; network data communications; control of the RFID tag reader 108; responses to inputs received from one or more input devices (e.g., keyboard, remote, game controller, mouse, etc.) 124; the execution of instructions stored on a tangible medium such as the data store 114; the generation of output signals to one or more output devices 126; and other functions.

The microprocessor 112 is configured to execute instructions of applications for performing various tasks. In one embodiment, the microprocessor 112 can access and execute instructions of a file execution application 130, which executes (i.e., plays) the copy of the original file 116, under certain conditions in accordance with the method. For instance, the file execution application 130 can play a video or music file, a video game or execute a computer program. The execution of the copy of the original file 116 can, for example, provide an output signal (e.g., audio signal, video signal, etc.) to the output device 126 (e.g., audio amplifier, video monitor, etc.).

Embodiments of the method are implemented by the system 100 through the execution of instructions by the microprocessor 112 stored in a tangible medium that correspond to the various method steps. Such instructions are generally represented by a RFID tag verification application 132.

In one embodiment of the method, an instruction to execute the digital copy of the original file 116 is received (140). The instruction can be provided to the microprocessor 112 by the user of the system 100 through, for example, the input device 124. Alternatively, the instruction can be generated by a program running on the system 100 or a remote client of the system 100. For instance, the file execution application 130 may provide the instruction to execute the copy of the original file 116 in response to the execution of a play list containing several music files, one of which is the copy of the original file 116. In one embodiment, the receipt of the instruction to execute the digital copy of the original file 116 results in the execution of the RFID tag verification application 132 by the microprocessor 112 and, thus, the steps of the method.

At 142 of the method, a RFID tag read operation is performed using the RFID tag reader 108. During the RFID tag read operation, an interrogatory signal is generated by the RFID tag reader 108 and is transmitted as a radio frequency signal through the antenna 122 into the surrounding area. The radio frequency interrogatory signal generated by the antenna 122 activates (i.e., powers) the RFID tag 106, which responsively transmits the data embedded within the tag, including the original file identifier 120, provided that the RFID tag 106 is within an operating range of the reader, which is represented by the circle 144 in FIG. 2.

At 146, a determination is made as to whether the physical storage medium 102 is preset or absent based on the RFID tag read operation. In the event that the RFID tag read operation fails to read data from a RFID tag 106 that is within the operating range of the reader 108, the physical storage medium 102 corresponding to the copy of the original file 116 is determined to be absent. Thus, when the tag 106 is outside the operating range 144 of the reader 108, as represented by the dashed box 106 in FIG. 2, the data from the tag 106 is not read and the corresponding physical storage medium 102 is determined to be absent.

In general, when data from one or more RFID tags 106 is read during the read operation, the determination regarding whether the physical storage medium 102 is present or absent is made based on a comparison of the read data (i.e., original file identifiers) to a copy file identifier 148 stored in the data store 114. Exemplary embodiments of the copy file identifier 148 include a code contained within the copy of the original file 116 and a code that is generated when the original file 104 is copied or installed in the data store 114.

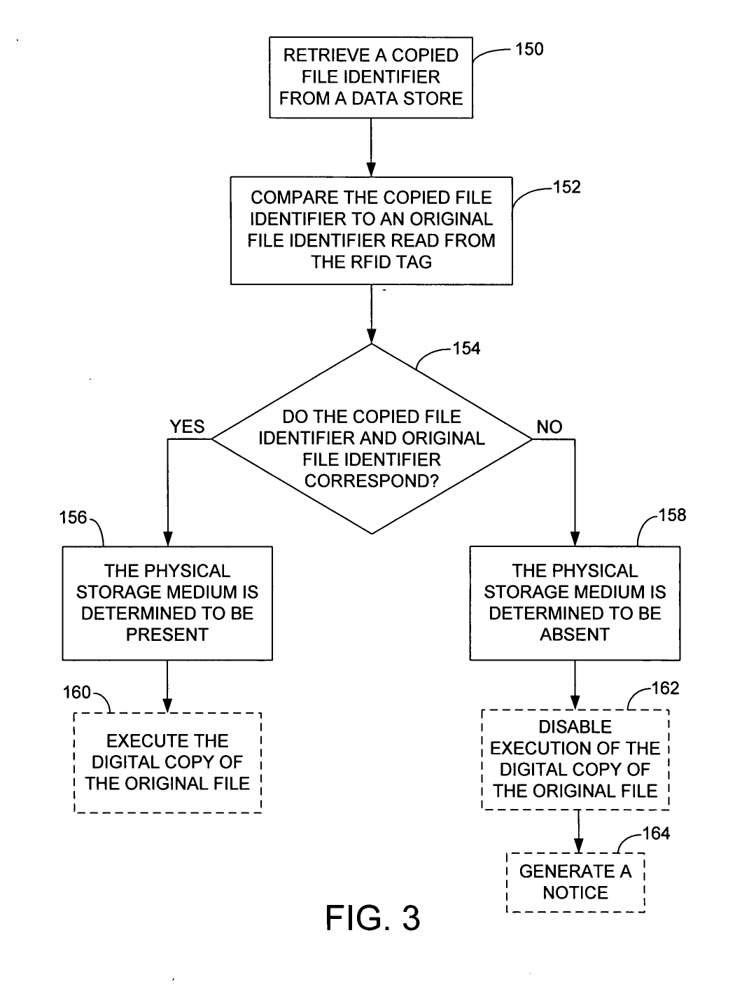

One exemplary embodiment of 146 of the method is illustrated in the flowchart of FIG. 3. At 150, the copy file identifier 148 corresponding to the digital copy of the original file 116 that is to be executed (140) is retrieved from the data store 114 by the microprocessor 112. At 152, a comparison is made between the retrieved copy file identifier 148 and one or more original file identifiers 120 obtained during the RFID tag read operation (142) to determine whether the two identifiers correspond at 154. In one embodiment, the retrieved copy file identifier 148 and/or the original file identifier 120 are decoded or decrypted during the comparison (152) to determine whether they correspond.

In one embodiment, the retrieved copy file identifier 148 and the original file identifier 120 correspond at 154 and the method moves to 156 when the retrieved copy file identifier 148 and the original file identifier 120 match or have another predetermined relationship to each other. In that case, the physical storage medium 102 is determined to be present as indicated at 156.

When the copy file identifier 148 and the original file identifier 120 do not correspond at 154, the physical storage medium 102 is determined to be absent as indicated at 158. In other words, when the RFID tag reader 108 fails to read the original file identifier 120 corresponding to the retrieved copy file identifier 148, the physical storage medium 102 containing the original file 104 is determined to be absent.

The digital copy of the original file 116 is executed, or authorized for execution, at 160 (FIGS. 1 and 3) when the physical storage medium 102 is determined to be present at 146. Execution of the digital copy of the original file 116 is disabled or unauthorized, as indicated at 162, when the physical storage medium 102 is determined be absent at 146.

In one embodiment, the system 100 generates a notice, at 164, that the physical storage medium 102 containing the original file 104 is not detected when it is determined at 146 that the physical storage medium 102 is absent. For example, the microprocessor can retrieve a predetermined notice from the data store 114 or other location and provide the notice to the user through the output device 126. Embodiments of the notice include a visual (i.e., graphical) and/or audible notification to the user indicating that the copy of the original file 116 cannot be executed or played because the presence of the physical storage medium 102 via the tag 106 has not been detected.

Thus, in accordance with the method, a user may rip or copy the original files 116 to a data store 114, from which execution of the copies of the original files 148 is more convenient than having to execute the original files 116 from the physical storage media 102, on which the original files 116 are stored. However, the copy of the original file 148 in the data store 114 will not execute unless the RFID tag 106 that is indicative of the presence or ownership of the licensed or authorized copy of the corresponding original file 116 is detected. Accordingly, embodiments can protect the seller of the original files from piracy while providing the user with the convenience of executing the original files from a chosen data store.

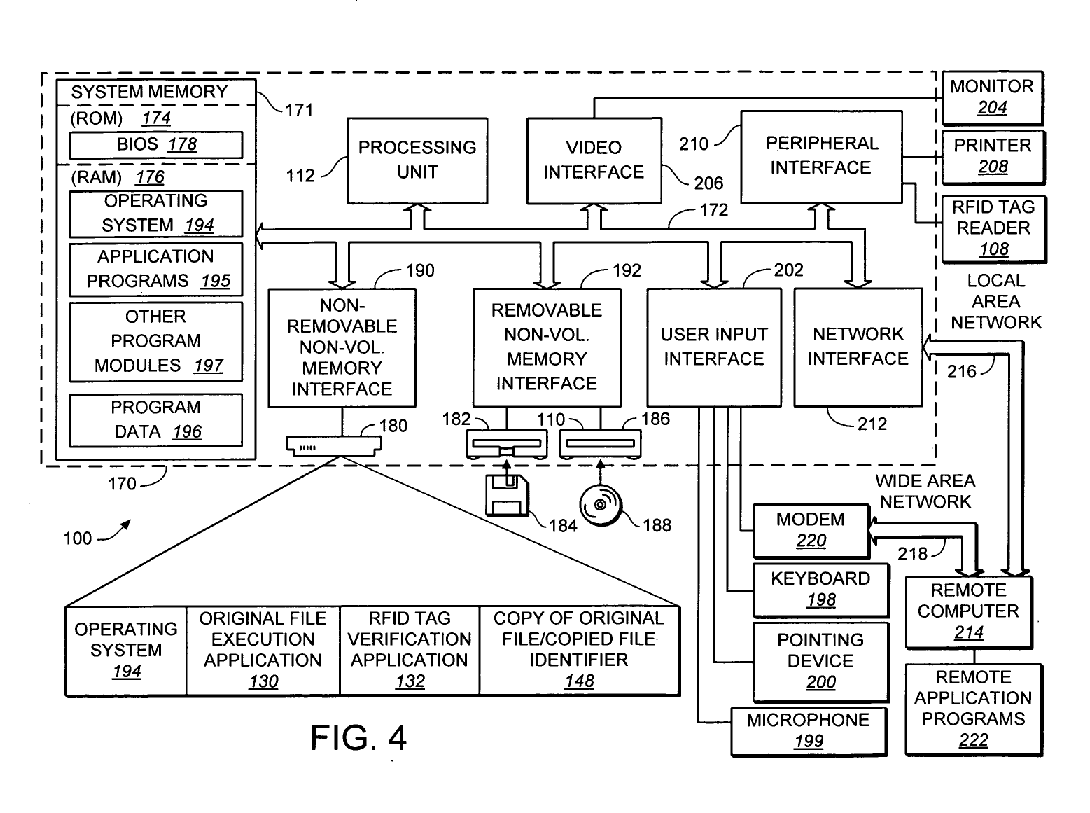

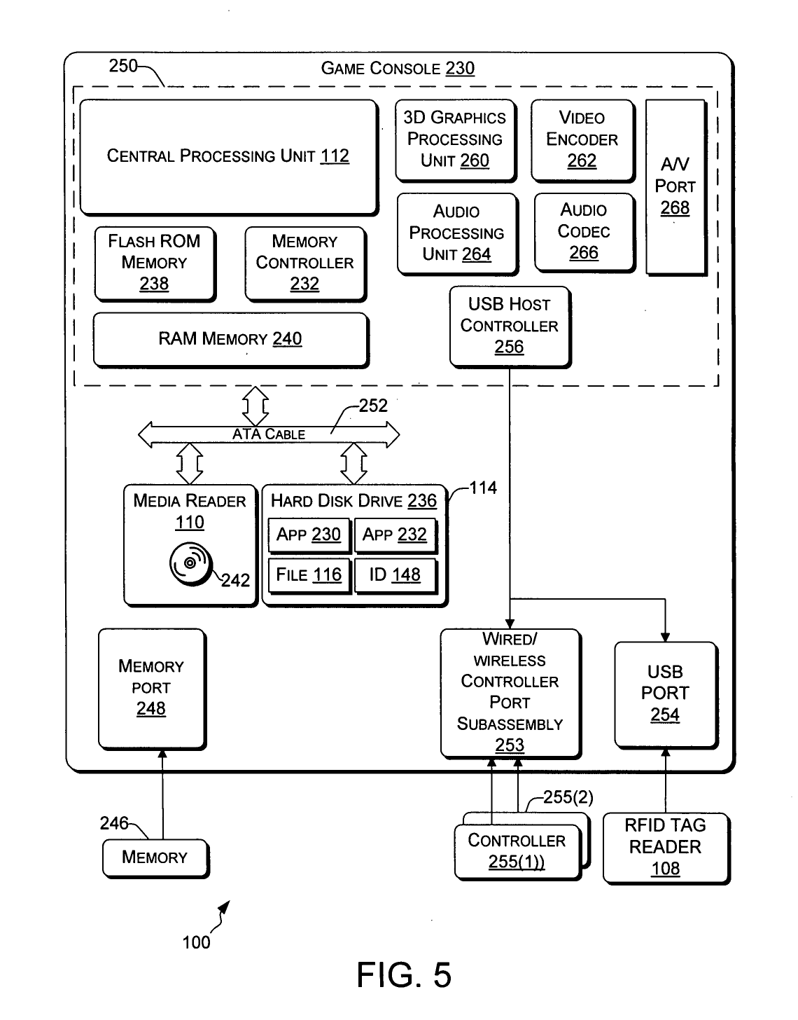

The system 100 configured to implement embodiments of the method can be formed, at least in part, by a suitable computing device. Exemplary computing devices include, for example, a computer, a media player (e.g., mp3 player, video player, CD player, DVD player, mobile phone, etc.) or a game console. The following discussion of FIGS. 4 and 5 is intended to provide a brief, general description of the system 100 respectively formed, in part, using a computer and a game console.

FIG. 4 is a block diagram of a computer 170. Components of computer 170 may include, but are not limited to, the microprocessor or processing unit 112, a system memory 171, and a system bus 172 that couples various system components including the system memory to the processing unit. System bus 172 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The system memory 171 includes computer storage media in the form of volatile and/or nonvolatile memory such as read only memory (ROM) 174 and random access memory (RAM) 176. A basic input/output system 178 (BIOS), containing the basic routines that help to transfer information between elements within the computer 170, such as during start-up, is typically stored in the ROM 174. The RAM 176 typically contains data and/or program modules that are immediately accessible to and/or presently being operated on by processing unit 112.

The computer 170 typically includes a variety of computer readable media, which can form the data store 114. Computer readable media can be any available media that can be accessed by the computer 170 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 170. By way of example only, FIG. 4 illustrates a hard disk drive 180 that reads from or writes to non-removable, nonvolatile magnetic media, a magnetic disk drive 182 that reads from or writes to a removable, nonvolatile magnetic disk 184. Also shown, is an optical disk drive 186 that reads from or writes to a removable, nonvolatile optical disk 188 such as a CD ROM or other optical media and can be used as the media reader 110 in accordance with embodiments.

The hard disk drive 180 is typically connected to the system bus 172 through a non-removable memory interface such as interface 190, and the magnetic disk drive 182 and the optical disk drive 186 are typically connected to the system bus 172 by a removable memory interface, such as interface 192.

The drives and their associated computer storage media discussed above and illustrated in FIG. 4, provide storage of computer readable instructions, data structures, program modules and other data for access and/or execution by the microprocessor or processing unit 112 of the computer 170. In FIG. 4, for example, hard disk drive 180 is illustrated as storing operating system 194, as well as application programs and, program data such as the file execution application 130, the RFID tag verification application 132, the copy of the original file 116 and the copy file identifier 148. The operating system 194, application programs 195, program data 196 and other program modules 197 can also be stored in various data stores of the computer 170 including the RAM 176, as shown in FIG. 4, or other data stores that are accessible by the processing unit 112.

A user may enter commands and information into the computer 170 through input devices 124 such as a keyboard 198, a microphone 199, and a pointing device 200, such as a mouse, trackball or touch pad. Other input devices (not shown) may include a joystick, game pad, satellite dish, scanner, or the like. These and other input devices are often connected to the processing unit 112 through a user input interface 202 that is coupled to the system bus, but may be connected by other interface and bus structures, such as a parallel port, game port or a universal serial bus (USB).

An output device 126 in the form of a monitor 204 or other type of display device is also connected to the system bus 172 via an interface, such as a video interface 206. In addition to the monitor, computers may also include other peripheral devices, such as a printer 208, which may be connected through a peripheral interface 210. The RFID tag reader 108 can couple to the microprocessor 112 or processing unit through the peripheral interface 210, or other suitable communication interface, such as network interface 212 (e.g., wired or wireless communication link).

The computer 170 is operated in a networked environment using logical connections to one or more remote computers, such as a remote computer 214. The remote computer 214 may be a personal computer, a hand-held device, a server, a router, a network PC, a peer device or other common network node, and typically includes many or all of the elements described above relative to the computer 170. The logical connections depicted in FIG. 4 include a local area network (LAN) 216 and a wide area network (WAN) 218, but may also include other networks. Such networking environments are commonplace in offices, enterprise-wide computer networks, Intranets and the Internet.

When used in a LAN networking environment, the computer 170 is connected to the LAN 216 through the network interface or adapter 212. When used in a WAN networking environment, the computer 170 typically includes a modem 220 or other means for establishing communications over the WAN 218, such as the Internet. The modem 220, which may be internal or external, may be connected to the system bus 172 via the user input interface 202, or other appropriate mechanism. In a networked environment, program modules, or portions thereof, depicted relative to the computer 170, such as the file execution application 130 and the RFID tag verification application 132, may be stored in a remote data store 114 of the remote computer 214 or other memory storage device. By way of example, and not limitation, FIG. 4 illustrates remote computer 214 having access to such application programs 222. It will be appreciated that the network connections shown are exemplary and other means of establishing a communications link between the computers may be used.

FIG. 5 is a block diagram of an exemplary game console 230 in accordance with various embodiments. The console 230 is generally configured for playing (i.e., executing) the original file 104 or the copy of the original file 116, which, as discussed above, can be a game, a music file, a video file, an application or other file. The console 230 includes the microprocessor or central processing unit (CPU) 112 that is configured to access and/or execute the file execution application 130, the RFID tag verification application 132, the copy of the original file 116 and the copy file identifier 148 from a data store 114 of the console 230 through a memory controller 232. The data stores 114 that are accessible by the CPU 112 include a hard drive 236, a flash Read Only Memory (ROM) 238, a Random Access Memory (RAM) 240, physical media 242 accessed through the media reader 110, such as optical disk media and a peripheral storage device such as memory 246 (e.g., flash memory) coupled to memory port 248 (e.g., USB port), and other data stores. The RFID tag verification application 132, the file execution application 130, the copy of the original file 116 and the copy file identifier 148 can be stored together or separately in one of these local data stores, such as the hard drive 236 as shown. Alternatively, these applications and data can be stored in a remote data store, such as a data server, that is coupled to the console through a network connection, for example.

In one implementation, the CPU 112, the memory controller 232, the ROM 238, and the RAM 240 are integrated onto a common module 250. In this implementation, the ROM 238 is configured as a flash ROM that is connected to the memory controller 232 via a Peripheral Component Interconnect (PCI) bus and a ROM bus (neither of which are shown). The RAM 240 is configured as multiple Double Data Rate Synchronous Dynamic RAM (DDR SDRAM) modules that are independently controlled by the memory controller 232 via separate buses (not shown). The hard disk drive 236 and the media reader 110 are shown connected to the memory controller via the PCI bus and an AT Attachment (ATA) bus 252. However, in other implementations, dedicated data bus structures of different types can also be applied in the alternative.

In some embodiments, the ROM 238 contains an operating system kernel that controls the basic operations of the console as executed by the CPU 112 and that exposes a collection of Application Programming Interfaces that can be called by games and other applications, such as the file execution application 130 and the RFID tag verification application 132.

The console 230 includes a wired/wireless controller port subassembly 253 configured to accommodate one or more wireless controllers, as represented by controllers 255(1) and 255(2), each of which can operate as the input device 124.

The RFID tag reader 108 can be included within the console 230 or coupled to a port, such as USB port 254 controlled by USB host controller 256, as shown. Other wired or wireless communication links between the RFID tag reader 108 and the microprocessor or CPU 112 can also be used.

A three-dimensional graphics processing unit 260 and a video encoder 262 form a video processing pipeline for high speed and high resolution (e.g., High Definition) graphics processing. Data are carried from graphics processing unit 260 to video encoder 262 via a digital video bus (not shown). An audio processing unit 264 and an audio codec (coder/decoder) 266 form a corresponding audio processing pipeline for multi-channel audio processing of various digital audio formats. Audio data are carried between audio processing unit 264 and audio codec 266 via a communication link (not shown). The video and audio processing pipelines output data to an A/V (audio/video) port 268 for transmission to an output device 126, such as a display or audio amplifier.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, implemented using a microprocessor, for controlling execution of a digital copy of an original file, the method comprising:
performing a radio frequency identification (RFID) tag read operation using a RFID tag reader;
determining whether the physical storage medium is present or absent based on the RFID tag read operation;
executing the digital copy of the original media file when the physical storage medium is determined to be present; and
disabling execution of the digital copy of the original media file when the physical storage medium is determined to be absent.

2. The method of claim 1, wherein:
the physical storage medium is determined to be present when an original media identifier from a memory of a RFID tag is read during the RFID tag read operation, the original media identifier uniquely identifying at least one of the physical storage medium and the original media file; and
the physical storage medium is determined to be absent when the RFID tag reader fails to read the original media identifier from the memory of the RFID tag coupled to the physical storage medium during the RFID tag read operation.

3. The method of claim 2, wherein the RFID tag is coupled to the physical storage medium.

4. The method of claim 1, wherein the determining whether the physical storage medium is present or absent based on the RFID tag read operation comprises:
retrieving a copy file identifier from a data store, the copy file identifier identifying the digital copy of the original file; and
comparing the copy file identifier to an original file identifier read from a RFID tag during the RFID tag read operation, the original media identifier uniquely identifying at least one of the physical storage medium and the original media file;
wherein the physical storage medium is determined to be present when the copy file identifier and the original file identifier correspond, and the physical storage medium is determined to be absent when the copy file identifier and the original file identifier do not correspond.

5. The method of claim 1, further comprising generating a notice that the physical storage medium containing the original file is not detected when it is determined that the physical storage medium is absent.

6. The method of claim 1, further comprising performing the RFID tag read operation in response to receiving an instruction to execute the digital copy of the original file.

7. The method of claim 1, wherein the original file is selected from the group consisting of a video file, an audio file, a video game and a computer program.

8. The method of claim 1, wherein the physical storage medium is selected from the group consisting of a CD-ROM, a DVD-ROM and a flash memory.

9. A method, implemented by a microprocessor, for controlling execution of a digital copy of an original file contained in a data store, the method comprising:
receiving an instruction to execute the digital copy of the original file;
performing a radio frequency identification (RFID) tag read operation using a RFID tag reader;
determining whether the physical storage medium is present or absent comprising:
retrieving a copy file identifier from a data store, the copy file identifier identifying the copy of the original file; and
comparing the copy file identifier to an original file identifier read during the RFID tag read operation, the original media identifier uniquely identifying at least one of the physical storage medium and the original media file;
wherein the physical storage medium is determined to be present when the copy file identifier and the original file identifier correspond, and the physical storage medium is determined to be absent when the copy file identifier and the original file identifier do not correspond;
executing the digital copy of the original file when the physical storage medium is determined to be present; and
disabling execution of the digital copy of the original file when the physical storage medium is determined to be absent.

10. The method of claim 9, further comprising:
receiving the physical storage medium containing the original file; and
forming the digital copy of the original file in the data store.

11. The method of claim 9, further comprising generating a notice that the physical storage medium containing the original file is not detected when it is determined that the physical storage medium is absent.

12. The method of claim 9, wherein the original file is selected from the group consisting of a video file, an audio file, a video game and a computer program.

13. The method of claim 9, wherein the physical storage medium is selected from the group consisting of a CD-ROM, a DVD-ROM and a flash memory.

14. A system for controlling execution of a digital copy of an original file, the original file stored in a physical storage medium, the system comprising:
a data store containing the digital copy of the original file;
a radio frequency identification (RFID) tag reader;
a microprocessor; and
instructions stored in a tangible medium and executable by the microprocessor to perform steps of:
receiving an instruction to execute the digital copy of the original file contained in the data store;
performing a RFID tag read operation using the RFID tag reader;
determining whether the physical storage medium is present or absent based on the RFID tag read operation;
executing the digital copy of the original media file when the physical storage medium is determined to be present; and
disabling the execution of the digital copy of the original media file when the physical storage medium is determined to be absent.

15. The system of claim 14, wherein:
the physical storage medium is determined to be present when the original media identifier from the memory of the RFID tag coupled to the physical storage medium is read during the RFID tag read operation, the original media identifier uniquely identifying at least one of the physical storage medium and the original media file; and
the physical storage medium is determined to be absent when the RFID tag reader fails to read the original media identifier from the memory of the RFID tag coupled to the physical storage medium during the RFID tag read operation.

16. The system of claim 14, wherein the instructions for determining whether the physical storage medium is present or absent based on the RFID tag read operation further comprise instructions for:
retrieving a copy file identifier from a data store, the copy file identifier identifying the digital copy of the original file; and
comparing the copy file identifier to an original file identifier read from a RFID tag during the RFID tag read operation, the original media identifier uniquely identifying at least one of the physical storage medium and the original media file;
wherein the physical storage medium is determined to be present when the copy file identifier and the original file identifier correspond, and the physical storage medium is determined to be absent when the copy file identifier and the original file identifier do not correspond.

17. The system of claim 16, wherein the instructions further comprise generating a notice that the physical storage medium containing the original file is not detected when it is determined that the physical storage medium is absent.

18. The system of claim 14, wherein the digital copy of the original file is selected from the group consisting of a video file, an audio file, a video game and a computer program.

19. The system of claim 14, wherein the physical storage medium is selected from the group consisting of a CD-ROM, a DVD-ROM and a flash memory.

20. The system of claim 14, wherein the RFID tag is coupled to the physical storage medium.
